(19) United States
(12) Patent Application Publication
(10) Pub. No.: US 2024/0061936 A1
(43) Pub. Date: Feb. 22, 2024

(54) Method and Apparatus for Detecting Malicious PE File and Device and Medium

(71) Applicant: Dbappsecurity Co.,Ltd, Hangzhou (CN)

(72) Inventors: Aocen PAN, Hangzhou (CN); Yuan FAN, Hangzhou (CN); Xin WANG, Hangzhou (CN); Xuefei SHUI, Hangzhou (CN); Tongjian AN, Hangzhou (CN); Da CHEN, Hangzhou (CN)

(21) Appl. No.: 18/234,898

(22) Filed: Aug. 17, 2023

(30) Foreign Application Priority Data
Aug. 17, 2022 (CN) 202210984153.9

(51) Int. Cl. G06F 21/56; G06N 3/08

(52) U.S. Cl. CPC G06F 21/565; G06N 3/08; G06F 2221/033

(57) ABSTRACT

The disclosure relates to the field of artificial intelligence. Disclosed in the disclosure are a method and apparatus for detecting a malicious Portable Executable (PE) file, and a device and a medium. The method includes: disassembling a target PE file according to a preset file disassembling method, so as to acquire file header information, file optional header information, file section header information, and section information; using a trained sparse self-encoding neural network model to respectively vectorize each piece of header information, and using a trained text classification model to vectorize the section information; and fusing each vectorized vector, and inputting fused vectors into a neural network model, so as to acquire a detection result outputted by the neural network model. The neural network model is obtained by using a preset knowledge transfer method to perform model transfer on each trained sparse self-encoding neural network model and text classification model.

### CROSS-REFERENCE TO RELATED DISCLOSURE

The present disclosure claims priority to Chinese Patent Disclosure No. 202210984153.9 filed to the China National Intellectual Property Administration on Aug. 17, 2022 and entitled “Method and Apparatus for Detecting Malicious PE File, and Device and Medium”, the disclosure of which is hereby incorporated by reference in its entirety.

### TECHNICAL FIELD

The disclosure relates to the field of artificial intelligence, and in particular, to a method and apparatus for detecting a malicious Portable Executable (PE) file, and a device and a medium.

### BACKGROUND

When malicious software is detected in a related art, a semantic feature and a structure feature are extracted from an assembly code and a function call graph of software to be detected, and whether the software has a malicious behavior is determined through a graph neural network. When the assembly code and the function call graph of the software to be detected are acquired, whether shelling is performed on a file needs to be determined with the help of other tools; and if shelling is performed on the file, a shelling-off operation needs to be performed. When the software is shell-free or after shelling-off is performed on the software, another third party tool is then used to inversely acquire an original assembly code of the software, and then the function call graph in the software is obtained according to an instruction line in the assembly code. Finally, a semantic feature vector is used to represent an assembly function; an attribute call graph is acquired after an assembly code feature is vectorized; and finally, the attribute call graph is used as an input to train a graph neural network model, so as to achieve malicious detection of a binary file.

A process of determining shelling and shelling-off is tedious in the related art; and current automated shelling-off technologies still require the use of software static analysis combined with a sandbox environment to call information. Manual repairing or checking are also needed after automated disassembly. An input of a final model in the related art is assembly function data that is obtained by the software to be detected through multi-step processing, such that the input of the model needs to be strongly coupled with shell checking and shelling-off tools, a disassembly tool, etc. That is to say, the technology is very dependent on some other tools, even if the graph neural network or other deep learning models have high accuracy in a particular dataset or model training, data deviation due to a preposition component greatly affects a final classification result in practical use. In addition, in practical use, more environmental dependencies are required, more memory and more computational resources are consumed, and stability and accuracy cannot be guaranteed as well.

Therefore, during the detection of malicious files, how to avoid situations such as high dependence on third-party tools due to existing PE malicious detection and classification schemes, more scheme constraints, and a small range of files covered by the schemes are problems to be solved in the art.

### SUMMARY

The disclosed embodiment provides a method for detecting a malicious PE file. The method includes the following operations.

A target PE file is disassembled according to a preset file disassembling method, so as to acquire file header information, file optional header information, file section header information, and section information corresponding to the file section header information, wherein the file header information, file optional header information and file section header information are corresponding to the target PE file.

A trained sparse self-encoding neural network model is used to vectorize the file header information, the file optional header information, and the file section header information, and a trained text classification model is used to vectorize the section information, respectively, so as to acquire a file header vector, a file optional header vector, a file section header vector, and a section information vector.

Vector fusion is performed on the file header vector, the file optional header vector, the file section header vector, and the section information vector, so as to obtain fused vectors.

The fused vectors are inputted into a neural network model, so as to acquire a file detection result that is outputted by the neural network model for the target PE file. The neural network model is a model that is obtained by using a preset knowledge transfer method to perform model transfer on each trained sparse self-encoding neural network model and the trained text classification model.

In some embodiments of the present disclosure, before the trained sparse self-encoding neural network model is used to vectorize the file header information, the file optional header information, and the file section header information, and the trained text classification model is used to vectorize the section information, respectively, the method further includes the following operations.

A preset number of PE sample files is acquired, and the PE sample files include a malicious PE sample file and a non-malicious PE sample file.

The PE sample files are disassembled according to the preset file disassembling method to obtain the file header information, the file optional header information, the file section header information, and the section information corresponding to the file section header information, and the file header information, the file optional header information, the file section header information, and the section information corresponding to the file section header information are successively inputted into a preset first sparse self-encoding neural network model, a preset second sparse self-encoding neural network model, a preset third sparse self-encoding neural network model, and a preset text classification model for model training, so as to acquire a trained preset first sparse self-encoding neural network model, a trained preset second sparse self-encoding neural network model and a trained preset third sparse self-encoding neural network model, and a trained text classification model.

In some embodiments of the present disclosure, after the file header information, the file optional header information, the file section header information, and the section information corresponding to the file section header information are successively inputted into the preset first sparse self-encoding neural network model, the preset second sparse self-encoding neural network model, the preset third sparse self-encoding neural network model, and the preset text classification model for model training, the method further includes the following operations.

A cross entropy loss function is generated through a probability that detection results outputted by each trained sparse self-encoding neural network model and the trained text classification model is malicious information or non-malicious information.

Target neural network parameters in each trained sparse self-encoding neural network model and the trained text classification model during a vectorization process are adjusted on the basis of the cross entropy loss function.

In some embodiments of the present disclosure, after vector fusion is performed on the file header vector, the file optional header vector, the file section header vector, and the section information vector, so as to obtain the fused vectors, the method further includes the following operation.

The target neural network parameters in each trained sparse self-encoding neural network model and the trained text classification model are frozen.

In some embodiments of the present disclosure, the operation of using the trained sparse self-encoding neural network model to respectively vectorize the file header information, the file optional header information, and the file section header information, and using the trained text classification model to vectorize the section information, so as to acquire the file header vector, the file optional header vector, the file section header vector, and the section information vector includes the following operations.

Fields in the file header information, the file optional header information, and the file section header information are respectively inputted into the trained preset first sparse self-encoding neural network model, the trained preset second sparse self-encoding neural network model and the trained preset third sparse self-encoding neural network model in a preset sorting manner, and the section information is inputted into the trained text classification model.

Outputs of hidden layers of the trained preset first sparse self-encoding neural network model, preset second sparse self-encoding neural network model and preset third sparse self-encoding neural network model are respectively used as the file header vector, the file optional header vector, and the file section header vector, and an output of fully connected layer in the trained text classification model is used as the section information vector.

In some embodiments of the present disclosure, before the fused vectors are inputted into the neural network model, the method further includes the following operation.

Model transfer is performed on the trained preset first sparse self-encoding neural network model, preset second sparse self-encoding neural network model and preset third sparse self-encoding neural network model, and the trained text classification model on the basis of the preset knowledge transfer method, so as to obtain the neural network model.

In some embodiments of the present disclosure, the operation of acquiring the file detection result that is outputted by the neural network model for the target PE file includes the following operation.

The file detection result that is outputted by the neural network model for the target PE file and includes eight soft label dimensions is acquired. The eight soft label dimensions include a malicious file header, a non-malicious file header, a malicious optional header, a non-malicious optional header, a malicious section header, a non-malicious section header, a malicious section, and a non-malicious section.

The disclosed embodiment provides an apparatus for detecting a malicious PE file. The apparatus includes a file disassembling component, an information vectorization component, a vector fusion component, and a result output component.

The file disassembling component is configured to disassemble a target PE file according to a preset file disassembling method, so as to acquire file header information, file optional header information, file section header information, and section information corresponding to the file section header information, wherein the file header information, file optional header information and file section header information are corresponding to the target PE file.

The information vectorization component is configured to use a trained sparse self-encoding neural network model to respectively vectorize the file header information, the file optional header information, and the file section header information, and use a trained text classification model to vectorize the section information, so as to acquire a file header vector, a file optional header vector, a file section header vector, and a section information vector.

The vector fusion component is configured to perform vector fusion on the file header vector, the file optional header vector, the file section header vector, and the section information vector, so as to obtain fused vectors.

The result output component is configured to input the fused vectors into a neural network model, so as to acquire a file detection result that is outputted by the neural network model for the target PE file. The neural network model is a model that is obtained by using a preset knowledge transfer method to perform model transfer on each trained sparse self-encoding neural network model and the trained text classification model.

The disclosed embodiment provides an electronic device, including a memory and a processor.

The memory is configured to store a computer program.

The processor is configured to execute the computer program, so as to implement the method for detecting the malicious PE file.

The disclosed embodiment provides a computer storage medium, which is configured to store a computer program. Steps of the method for detecting the malicious PE file is implemented when the computer program is executed by a processor.

### BRIEF DESCRIPTION OF THE DRAWINGS

In order to more clearly illustrate the embodiments of the disclosure or the technical solutions in the related art, the drawings used in the description of the embodiments or the related art will be briefly described below. It is apparent that the drawings in the following descriptions are merely the embodiments of the disclosure. Other drawings can be obtained from those skilled in the art according to the provided drawings without any creative work.

FIG. 1 is a flowchart of a method for detecting a malicious PE file provided in the embodiments of the present disclosure.

FIG. 2 is a schematic diagram of structure information of a PE file provided in the embodiments of the present disclosure.

FIG. 3 is a schematic diagram of a file disassembling process provided in the embodiments of the present disclosure.

FIG. 4 is a schematic diagram of file information vectorization provided in the embodiments of the present disclosure.

FIG. 5 is a schematic diagram of vector fusion provided in the embodiments of the present disclosure.

FIG. 6 is a flowchart of a specific method for detecting a malicious PE file provided in the embodiments of the present disclosure.

FIG. 7 is a schematic diagram of partial information of a section header provided in the embodiments of the present disclosure.

FIG. 8 is a schematic diagram of a structural relationship of a sparse self-encoding neural network model provided in the embodiments of the present disclosure.

FIG. 9 is a schematic diagram of basic information of a file provided in the embodiments of the present disclosure.

FIG. 10 is a schematic diagram of section header information provided in the embodiments of the present disclosure.

FIG. 11 is a schematic diagram of hexadecimal information provided in the embodiments of the present disclosure.

FIG. 12 is another schematic diagram of hexadecimal information provided in the embodiments of the present disclosure.

FIG. 13 is a schematic diagram of specific vector fusion provided in the embodiments of the present disclosure.

FIG. 14 is a schematic structural diagram of a classification model provided in the embodiments of the present disclosure.

FIG. 15 is a schematic flowchart of a classification model provided in the embodiments of the present disclosure.

FIG. 16 is a schematic structural diagram of an apparatus for detecting a malicious PE file provided in the embodiments of the present disclosure.

FIG. 17 is a structural diagram of an electronic device provided in the embodiments of the present disclosure.

### DETAILED DESCRIPTION OF THE EMBODIMENTS

The technical solutions in the embodiments of the disclosure will be clearly and completely described below in combination with the drawings in the embodiments of the disclosure. It is apparent that the described embodiments are only part of the embodiments of the disclosure, not all the embodiments. Based on the embodiments in the disclosure, all other embodiments obtained by those of ordinary skill in the art without creative work shall fall within the protection scope of the disclosure.

In the related art, when PE malicious software is detected and classified, dependence on third-party tools is strong, there are more constraints on schemes, and the range of files covered by the schemes is small. In the disclosure, malicious monitoring of PE files can be realized by means of performing structured disassembly on PE structural properties and through a targeted vectorization processing method. Therefore, the method is highly-targeted, more concise in process, and complete in data transmission.

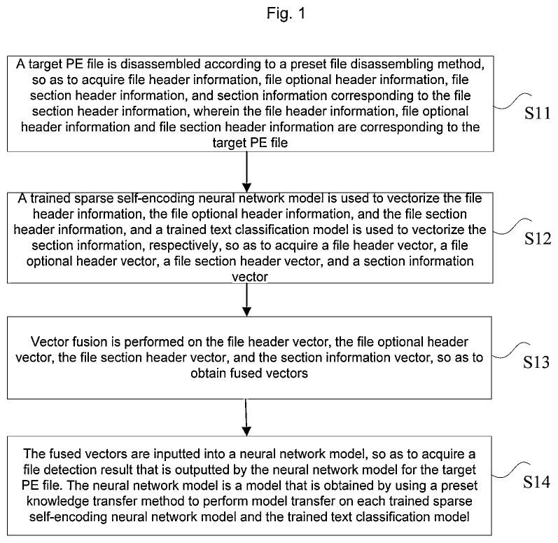

An embodiment of the disclosure discloses a method for detecting a malicious PE file. Referring to FIG. 1, the method includes the following steps.

At S11, a target PE file is disassembled according to a preset file disassembling method, so as to acquire file header information, file optional header information, file section header information, and section information corresponding to the file section header information, wherein the file header information, file optional header information and file section header information are corresponding to the target PE file.

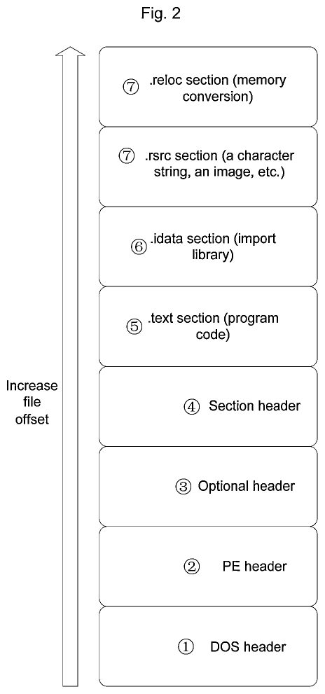

Structural information of the PE file is shown in FIG. 2. The format of the PE file includes a series of headers, which are configured to cause an operating system to load programs into a memory, and further includes a series of sections, which are configured to store actual program data, and Windows loads these sections into the memory, so as to cause the offset of the sections in the memory to correspond to display positions of the sections on a disk. In some embodiments of the present disclosure, other structural information other than a DOS header (the DOS header is a legacy product of a Microsoft DOS operating system from the 1980s and exists only for compatibility reasons) is used as important information for malicious software detection and classification.

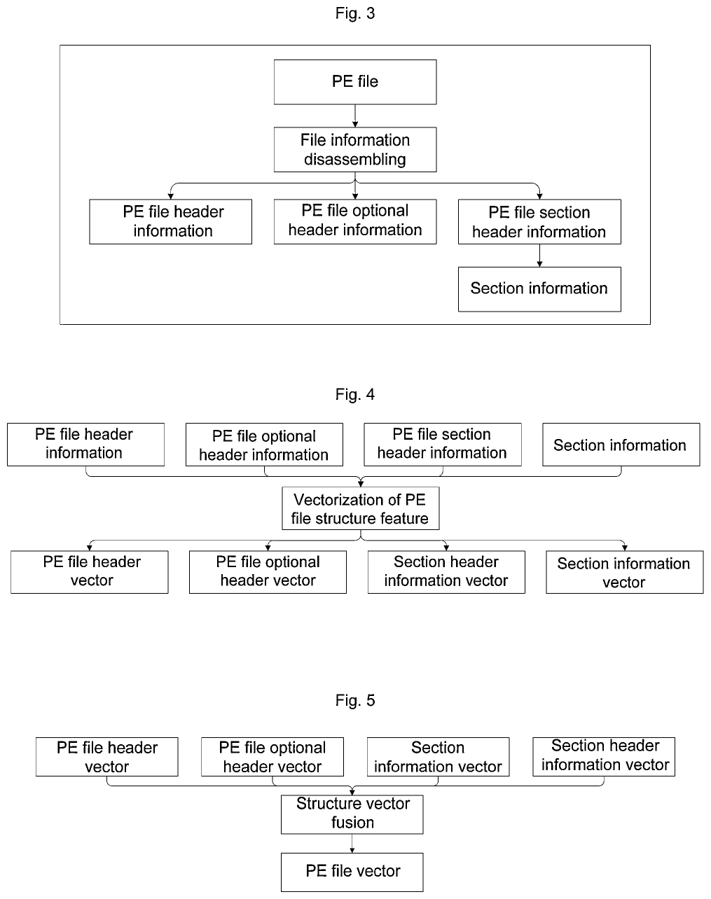

FIG. 3 is a schematic diagram of a file disassembling process provided in the embodiments of the present disclosure. The PE file is disassembled into the following information.
1. PE file header (FILE_HEADER) information, including basic information of a file.
2. PE file optional header (OPTIONAL_HEADER) information, including the way of loading a target program into the memory and other advanced detailed information about the program.
3. PE file section header (PE Sections) information, where a section header defines which permissions Windows should grant to sections, for example, whether a program should be readable, writable or executable when being executed; and the section header information describes PointerToRawData (an offset start address) and SizeOfRawData (a physical memory size) of each section, and an end position of each section may be obtained by adding the PointerToRawData and the SizeOfRawData, such that an actual position of each section in the PE file can be obtained, so as to determine the section information according to the positions of the sections.

At S12, a trained sparse self-encoding neural network model is used to vectorize the file header information, the file optional header information, and the file section header information, and a trained text classification model is used to vectorize the section information, respectively, so as to acquire a file header vector, a file optional header vector, a file section header vector, and a section information vector.

In some embodiments of the present disclosure, as shown in FIG. 4, in this step, the file header vector, the file optional header vector, the file section header vector, and the section information vector are determined by vectorizing the PE file header information, the PE file optional header information, the PE file section header information, and the section information. In some embodiments of the present disclosure, in combination with machine learning and deep learning, a vectorization component using a PE file structure feature may vectorize different structure components of the disassembled PE file through a downstream task.

In some embodiments of the present disclosure, header information such as the file header information, the file optional header information, and the file section header information is vectorized in a sparse self-encoding manner; and the section information is vectorized by means of a hexadecimal sequence and textCNN. In some embodiments of the present disclosure, the text classification model includes, but is not limited to, the textCNN.

At S13, vector fusion is performed on the file header vector, the file optional header vector, the file section header vector, and the section information vector, so as to obtain fused vectors.

FIG. 5 is a schematic diagram of vector fusion provided in the embodiments of the present disclosure. That is to say, the PE file header vector, the PE file optional header vector, the PE file section header vector, and the section information vector are fused into a PE file vector.

In some embodiments of the present disclosure, the vectorized vectors may be fused in a preset structure vector fusion component, and malicious PE file detection is realized by using a machine learning model or a heuristic rule.

At S14, the fused vectors are inputted into a neural network model, so as to acquire a file detection result that is outputted by the neural network model for the target PE file. The neural network model is a model that is obtained by using a preset knowledge transfer method to perform model transfer on each trained sparse self-encoding neural network model and the trained text classification model.

In some embodiments of the present disclosure, the step of acquiring the file detection result that is outputted by the neural network model for the target PE file may include: acquiring the file detection result that is outputted by the neural network model for the target PE file and comprises eight soft label dimensions, where the eight soft label dimensions include a malicious file header, a non-malicious file header, a malicious optional header, a non-malicious optional header, a malicious section header, a non-malicious section header, a malicious section, and a non-malicious section.

In some embodiments of the present disclosure, the sparse self-encoding neural network model generates a result that corresponding information is malicious information or non-malicious information; and after knowledge transfer, the results are integrated, so as to generate the file detection result with the eight soft label dimensions. Each piece of information, that is, the file header information, the file optional header information, the file section header information, and the section information, has a corresponding detection result, such that the result with the corresponding soft label dimension is generated in the finally-generated detection result. For example, a detection result of a PE file is a malicious file header, a non-malicious optional header, a non-malicious section header, and a non-malicious section, such that, in this case, it may be determined that the file header information of the PE file carries the malicious information, and the file optional header information, the file section header information, and the section information do not carry the malicious information.

In some embodiments of the present disclosure, the target PE file is disassembled according to the preset file disassembling method, so as to acquire the file header information, the file optional header information, the file section header information, and the section information corresponding to the file section header information, wherein the file header information, file optional header information and file section header information are corresponding to the target PE file; the trained sparse self-encoding neural network model is used to vectorize the file header information, the file optional header information, and the file section header information, and the trained text classification model is used to vectorize the section information, respectively, so as to acquire the file header vector, the file optional header vector, the file section header vector, and the section information vector; vector fusion is performed on the file header vector, the file optional header vector, the file section header vector, and the section information vector, so as to obtain the fused vectors; and the fused vectors are inputted into a neural network model, so as to acquire the file detection result that is outputted by the neural network model for the target PE file. The neural network model is the model that is obtained by using the preset knowledge transfer method to perform model transfer on each trained sparse self-encoding neural network model and the trained text classification model. In this way, in this embodiment, the PE file is disassembled into the file header information, the file optional header information, the file section header information, and the section information; and after independent malicious detection is separately performed on structure information of four dimensions in the PE file, malicious detection of the entire PE file is realized by using the preset knowledge transfer method. The disclosure is highly-targeted, highly-explanatory, and high in accuracy by means of performing structured disassembly on PE structural properties and through a targeted vectorization processing method. Compared with a method of first performing shelling-off, then performing disassembly, and then using semantic features to perform malicious detection in the related art, the method does not need to determine whether a file is with or without a shell, or may even use, as a target task, the fact that whether the file is with or without a shell, such that the method has higher universality. In addition, structure information used in the disclosure includes the semantic features and discards interpolation data during an image conversion process, and other tools are not required, such that the method is more concise in process and complete in data transmission, and has more practical scenarios and a faster response speed.

FIG. 6 is a flowchart of a method for detecting a malicious PE file provided in the embodiments of the present disclosure. Referring to FIG. 6, the method includes the following steps.

At S21, the preset number of PE sample files is acquired, and the PE sample files include a malicious PE sample file and a non-malicious PE sample file.

In some embodiments of the present disclosure, the PE sample files are segmented into a training set, a verification set, and a test set according to a segmentation ratio of 6:2:2. In some embodiments of the present disclosure, in the malicious PE sample file, some malicious software may be used as the malicious PE sample file, and a large number of green security software corresponding to the malicious software is used as the non-malicious PE sample file.

At S22, the PE sample files are disassembled according to the preset file disassembling method to obtain the file header information, the file optional header information, the file section header information, and the section information corresponding to the file section header information, and the file header information, the file optional header information, the file section header information, and the section information corresponding to the file section header information are successively inputted into a preset first sparse self-encoding neural network model, a preset second sparse self-encoding neural network model, a preset third sparse self-encoding neural network model, and a preset text classification model for model training, so as to acquire a trained preset first sparse self-encoding neural network model, a trained preset second sparse self-encoding neural network model and a trained preset third sparse self-encoding neural network model, and a trained text classification model.

In some embodiments of the present disclosure, the file header information, the file optional header information, and the file section header information are vectorized by using the sparse self-encoding neural network model; and the section information is vectorized by using the preset text classification model. In addition, in some embodiments of the present disclosure, the preset first sparse self-encoding neural network model, the preset second sparse self-encoding neural network model, the preset third sparse self-encoding neural network model, and the trained text classification model are all classification models that may output sample classification results.

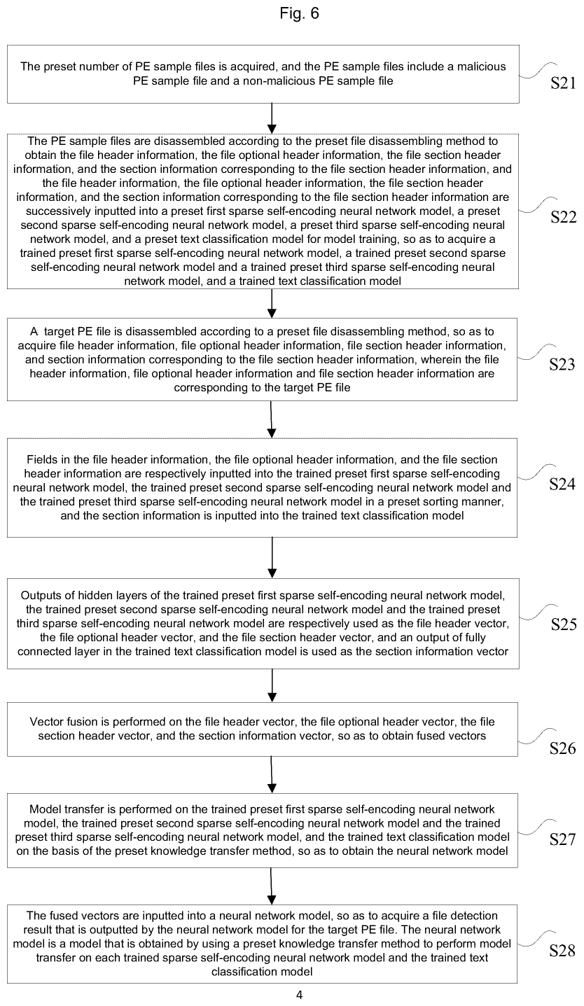

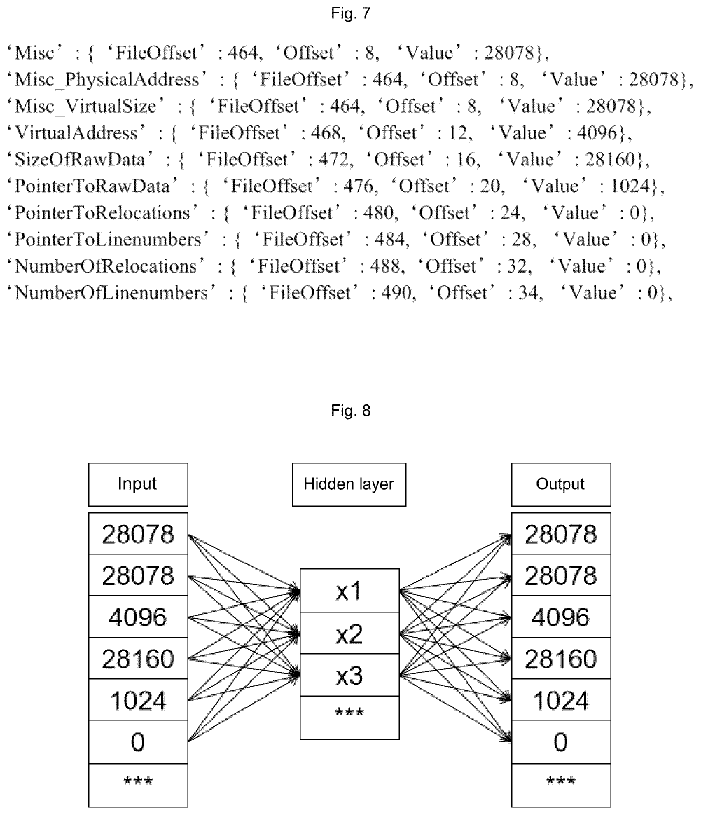

In some embodiments of the present disclosure, during the process of vectorization of the sparse self-encoding neural network model, by using the file header information as an example, field information in the file header information includes [Misc_PhysicalAddress, VirtualAddress, PointerToRawData, PointerToRelocations, PointerToLinenumbers, NumberOfRelocations, Characteristics]. Potential structures and correlation information of these fields may be obtained by the sparse self-encoding neural network model through training. The process includes: sorting, as an input and an output, all header information field values according to a fixed sequence, and putting the header information field values in the constructed sparse self-encoding neural network model for training, to obtain a function through training, so as to cause the input to be equal to the output; taking a neuron of an intermediate hidden layer to replace the header information; and after training is completed, taking output of each intermediate hidden layer as a vector representation of the header information. In some embodiments of the present disclosure, partial information of some section header is shown in FIG. 7; and FIG. 8 is a schematic diagram of a structural relationship of an input layer, a hidden layer, and an output layer in the sparse self-encoding neural network model.

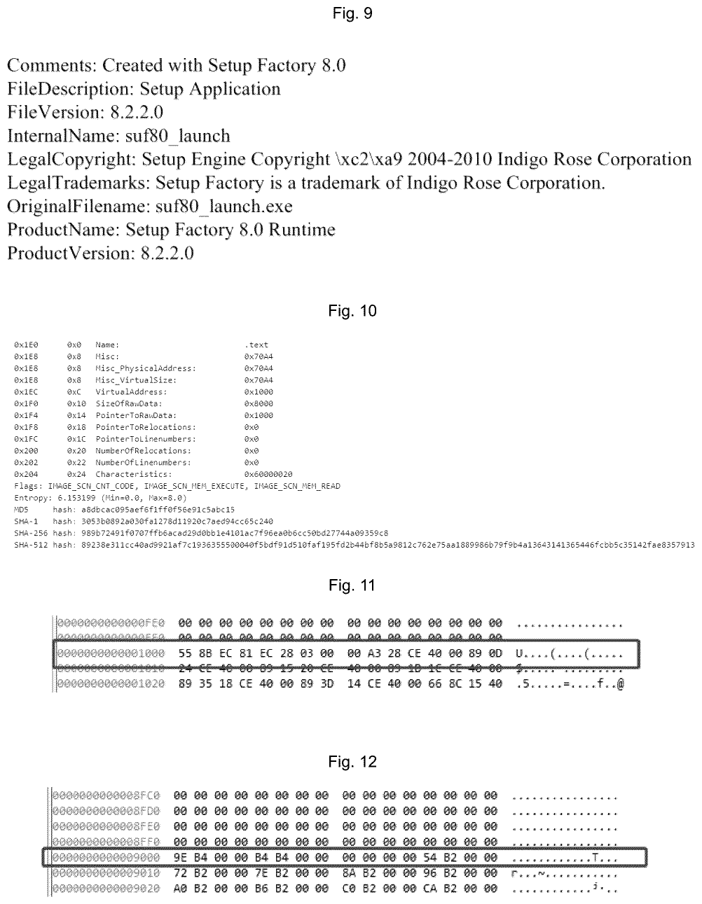

In some embodiments of the present disclosure, during the process of using the preset text classification model to vectorize the section information, a physical address of each section in the file is acquired by means of the section header information, and the sequence is read to be regarded as each section of data of the file. By using a file suf80_launch.exe as an example, FIG. 9 shows basic information of the suf80_launch.exe file; the .text section header information of the file is shown in FIG. 10; and it may be learned from the figure that, the section SizeOfRawData (an occupied memory size): 0x8000, and PointerToRawData (a start position of the section): 0x1000. Correspondingly, from a hexadecimal table (that is, in FIG. 11 and FIG. 12) of the file, it may be learned that the data is stored starting at 0x1000 and ending at 0x1000+0x8000=0x9000; then the file is read in a binary stream manner and stored as a hexadecimal list; and bits 4096(0x1000) to 36864(0x9000) of the list represent all information of the .text section of the file. Likewise, all section header information and the corresponding section information may be acquired.

In some embodiments of the present disclosure, when a model is trained, the same training set and verification set are guaranteed to be used to train a malicious software classification task during the entire process, the same number of fully connected nodes is trained at the last layers of all models, and the outputs of fully connected layers are used as structure component vectors.

For example, there are PE samples A, B, C, . . . , PE header information A_pehd of an A sample, optional header information A_ophd of A, a plurality of pieces of section header information A_sehds of A, and section information A_sebn of A may be acquired from the sample A. A_pehd, B_pehd, C_pehd, and the like may be vectorized in an optional sparse self-encoding manner, so as to obtain a vector of the PE file header information, and a classification model 1 is trained according to the vector. Similarly, a vector of the PE file optional header information and a vector of the section header information are obtained by means of vectorization of optional sparse self-encoding; and then a classification model 2 is trained according to the vector, and a classification model 3 is trained according to the vector. A vector of the section information is obtained by using the hexadecimal sequence and textcnn, and a classification model 4 is trained according to the vector.

In some embodiments of the present disclosure, after the PE sample files are disassembled according to the preset file disassembling method, and the file header information, the file optional header information, the file section header information, and the section information corresponding to the file section header information, which are obtained after disassembling, are successively inputted into the preset first sparse self-encoding neural network model, the preset second sparse self-encoding neural network model, the preset third sparse self-encoding neural network model, and the preset text classification model for model training, the method may further include: generating a cross entropy loss function through the probability that detection results outputted by each trained sparse self-encoding neural network model and the trained text classification model is malicious information or non-malicious information; and adjusting, on the basis of the cross entropy loss function, target neural network parameters in each trained sparse self-encoding neural network model and the trained text classification model during a vectorization process.

In some embodiments of the present disclosure, after different vectorization, the probability of two categories is outputted by means of the fully connected layer, and neural network parameters during vectorization are adjusted through cross entropy loss. In some embodiments of the present disclosure, 4 classification models may be trained by using structure information of four dimensions in the PE file.

At S23, a target PE file is disassembled according to a preset file disassembling method, so as to acquire file header information, file optional header information, file section header information, and section information corresponding to the file section header information, wherein the file header information, file optional header information and file section header information are corresponding to the target PE file.

At S24, fields in the file header information, the file optional header information, and the file section header information are respectively inputted into the trained preset first sparse self-encoding neural network model, the trained preset second sparse self-encoding neural network model and the trained preset third sparse self-encoding neural network model in a preset sorting manner, and the section information is inputted into the trained text classification model.

At S25, outputs of hidden layers of the trained preset first sparse self-encoding neural network model, the trained preset second sparse self-encoding neural network model and the trained preset third sparse self-encoding neural network model are respectively used as the file header vector, the file optional header vector, and the file section header vector, and an output of fully connected layer in the trained text classification model is used as the section information vector.

At S26, vector fusion is performed on the file header vector, the file optional header vector, the file section header vector, and the section information vector, so as to obtain fused vectors.

In some embodiments of the present disclosure, after vector fusion is performed on the file header vector, the file optional header vector, the file section header vector, and the section information vector, so as to obtain the fused vectors, the method may further include: freezing the target neural network parameters in each trained sparse self-encoding neural network model and the trained text classification model.

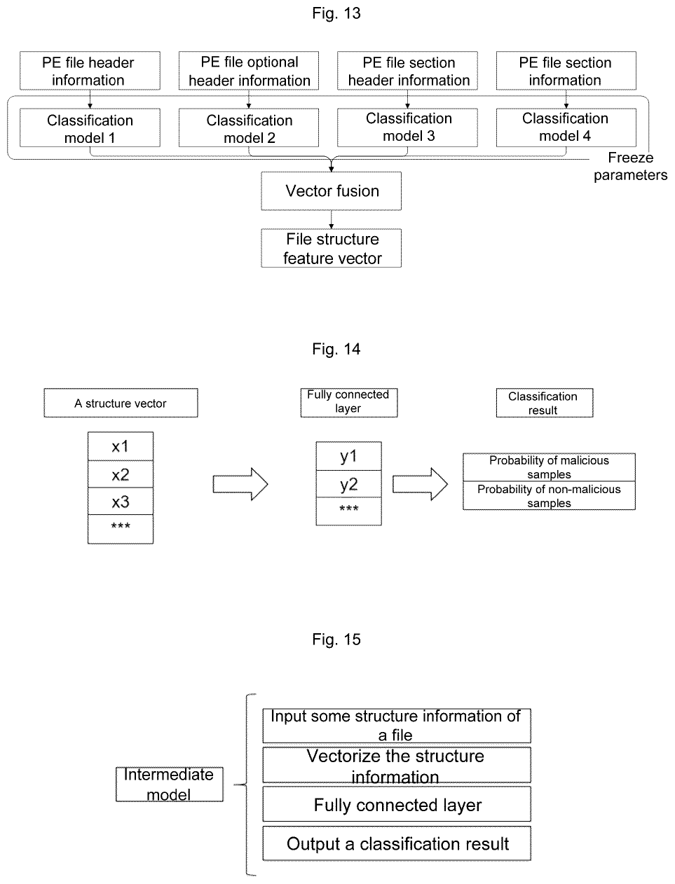

In some embodiments of the present disclosure, different inputs done for the same task are fused with an intermediate model, so as to obtain a structure feature vector of the file, that is, after the vectors are fused, the parameters of each classification model are frozen, the updating of the parameters are stopped only for a computation action, and the training is continued by fusing all vectorized structure data. FIG. 13 is a schematic diagram of vector fusion provided in the embodiments of the present disclosure. By means of the header information and the classification model corresponding to the section information, vector fusion may be performed, so as to obtain the file structure feature vector corresponding to the PE file.

At S27, model transfer is performed on the trained preset first sparse self-encoding neural network model, the trained preset second sparse self-encoding neural network model and the trained preset third sparse self-encoding neural network model, and the trained text classification model on the basis of the preset knowledge transfer method, so as to obtain the neural network model.

At S28, the fused vectors are inputted into a neural network model, so as to acquire a file detection result that is outputted by the neural network model for the target PE file. The neural network model is a model that is obtained by using a preset knowledge transfer method to perform model transfer on each trained sparse self-encoding neural network model and the trained text classification model.

In some embodiments of the present disclosure, the step of acquiring the file detection result that is outputted by the neural network model for the target PE file may include: acquiring the file detection result that is outputted by the neural network model for the target PE file and comprises eight soft label dimensions, where the eight soft label dimensions include a malicious file header, a non-malicious file header, a malicious optional header, a non-malicious optional header, a malicious section header, a non-malicious section header, a malicious section, and a non-malicious section.

In some embodiments of the present disclosure, the classification of each model is based on different information from a PE structure, but the classification results are fixed. FIG. 14 is a schematic structural diagram of a classification model. The model outputs corresponding information that is the probability of a malicious sample and the probability of a non-malicious sample. In some embodiments of the present disclosure, malicious or non-malicious categories outputted by the 4 classification models may also be merged into 8 eight soft label dimensions, which are a malicious file header, a non-malicious file header, a malicious optional header, a non-malicious optional header, a malicious section header, a non-malicious section header, a malicious section, and a non-malicious section; and loss is computed according to a final binary classification result, so as to adjust the parameters. In order to enrich the soft label dimensions, the fully connected layers of the 4 classification models are merged as the soft label dimension.

It is understandable that, FIG. 15 is a schematic flowchart of each classification model provided in the embodiments of the present disclosure. That is to say, after the file structure information is inputted, the structure information is vectorized, the fully connected layer is generated, and then the classification result corresponding to the information is finally outputted.

In some embodiments of the present disclosure, the target PE file is disassembled according to the preset file disassembling method, so as to acquire the file header information, the file optional header information, the file section header information, and the section information corresponding to the file section header information, wherein the file header information, file optional header information and file section header information are corresponding to the target PE file; the trained sparse self-encoding neural network model is used to vectorize the file header information, the file optional header information, and the file section header information, and the trained text classification model is used to vectorize the section information, respectively, so as to acquire the file header vector, the file optional header vector, the file section header vector, and the section information vector; vector fusion is performed on the file header vector, the file optional header vector, the file section header vector, and the section information vector, so as to obtain the fused vectors; and the fused vectors are inputted into a neural network model, so as to acquire the file detection result that is outputted by the neural network model for the target PE file. The neural network model is the model that is obtained by using the preset knowledge transfer method to perform model transfer on each trained sparse self-encoding neural network model and the trained text classification model. In this way, in this embodiment, the PE file is disassembled into the file header information, the file optional header information, the file section header information, and the section information; and after independent malicious detection is separately performed on structure information of four dimensions in the PE file, malicious detection of the entire PE file is realized by using the preset knowledge transfer method. The disclosure is highly-targeted, highly-explanatory, and high in accuracy by means of performing structured disassembly on PE structural properties and through a targeted vectorization processing method. Compared with a method of first performing shelling-off, then performing disassembly, and then using semantic features to perform malicious detection in the related art, the method does not need to determine whether a file is with or without a shell, or may even use, as a target task, the fact that whether the file is with or without a shell, such that the method has higher universality. In addition, structure information used in the disclosure includes the semantic features and discards interpolation data during an image conversion process, and other tools are not required, such that the method is more concise in process and complete in data transmission, and has more practical scenarios and a faster response speed.

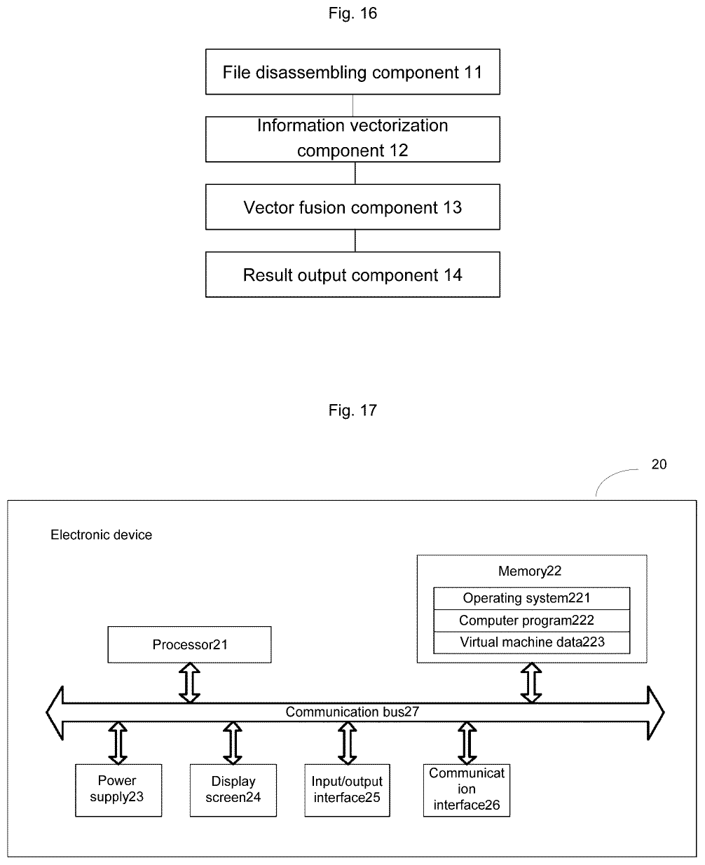

Referring to FIG. 16, an embodiment of the disclosure discloses an apparatus for detecting a malicious PE file. The apparatus may specifically include a file disassembling component, an information vectorization component, a vector fusion component, and a result output component.

The file disassembling component 11 is configured to disassemble a target PE file according to a preset file disassembling method, so as to acquire file header information, file optional header information, file section header information, and section information corresponding to the file section header information, wherein the file header information, file optional header information and file section header information are corresponding to the target PE file.

The information vectorization component 12 is configured to respectively use a trained sparse self-encoding neural network model to vectorize the file header information, the file optional header information, and the file section header information, and use a trained text classification model to vectorize the section information, so as to acquire a file header vector, a file optional header vector, a file section header vector, and a section information vector.

The vector fusion component 13 is configured to perform vector fusion on the file header vector, the file optional header vector, the file section header vector, and the section information vector, so as to obtain fused vectors.

The result output component 14 is configured to input the fused vectors into a neural network model, so as to acquire a file detection result that is outputted by the neural network model for the target PE file. The neural network model is a model that is obtained by using a preset knowledge transfer method to perform model transfer on each trained sparse self-encoding neural network model and the trained text classification model.

In some embodiments of the present disclosure, the target PE file is disassembled according to the preset file disassembling method, so as to acquire the file header information, the file optional header information, the file section header information, and the section information corresponding to the file section header information, wherein the file header information, file optional header information and file section header information are corresponding to the target PE file; the trained sparse self-encoding neural network model is used to vectorize the file header information, the file optional header information, and the file section header information, and the trained text classification model is used to vectorize the section information, respectively, so as to acquire the file header vector, the file optional header vector, the file section header vector, and the section information vector; vector fusion is performed on the file header vector, the file optional header vector, the file section header vector, and the section information vector, so as to obtain the fused vectors; and the fused vectors are inputted into a neural network model, so as to acquire the file detection result that is outputted by the neural network model for the target PE file. The neural network model is the model that is obtained by using the preset knowledge transfer method to perform model transfer on each trained sparse self-encoding neural network model and the trained text classification model. In this way, in this embodiment, the PE file is disassembled into the file header information, the file optional header information, the file section header information, and the section information; and after independent malicious detection is separately performed on structure information of four dimensions in the PE file, malicious detection of the entire PE file is realized by using the preset knowledge transfer method. The disclosure is highly-targeted, highly-explanatory, and high in accuracy by means of performing structured disassembly on PE structural properties and through a targeted vectorization processing method. Compared with a method of first performing shelling-off, then performing disassembly, and then using semantic features to perform malicious detection in the related art, the method does not need to determine whether a file is with or without a shell, or may even use, as a target task, the fact that whether the file is with or without a shell, such that the method has higher universality. In addition, structure information used in the disclosure includes the semantic features and discards interpolation data during an image conversion process, and other tools are not required, such that the method is more concise in process and complete in data transmission, and has more practical scenarios and a faster response speed.

Further, an embodiment of the disclosure further discloses an electronic device. FIG. 17 is a structural diagram of an electronic device 20 provided in the embodiments of the present disclosure. The content in the figure is not to be considered as any limitation on the scope of use of the disclosure.

FIG. 17 is a schematic structural diagram of an electronic device 20 provided in the embodiments of the present disclosure. The electronic device 20 may specifically include at least one processor 21, at least one memory 22, a power supply 23, a display screen 24, an input/output interface 25, a communication interface 26, and a communication bus 27. The memory 22 is configured to store a computer program, and the computer program is loaded and executed by the processor 21, so as to implement related steps in the method for detecting the malicious PE file disclosed in any one of the above embodiments. In addition, the electronic device 20 in this embodiment may specifically be an electronic computer.

In some embodiments of the present disclosure, the power supply 23 is configured to supply a working voltage to each hardware device on the electronic device 20. The communication interface 26 can create a data transmission channel between the electronic device 20 and an external device; and a communication protocol followed by the communication interface is any communication protocol that can be applicable to the technical solutions of the disclosure, and is not specifically limited herein. The input/output interface 25 is configured to acquire data inputted externally or output the data to the outside world; and a specific interface type may be selected according to specific application requirements, and is not specifically limited herein.

In addition, as a carrier of resource storage, the memory 22 may be a read-only memory, a random memory, a disk or an optical disk, etc. Resources stored on the memory may include an operating system 221, a computer program 222, and virtual machine data 223; and the virtual machine data 223 may include various data. A storage mode may be transient or permanent.

The operating system 221 is configured to manage and control each hardware device on the electronic device 20 and the computer program 222, and may be Windows Server, Netware, Unix, Linux, etc. In addition to including the computer program that can be configured to complete the method for detecting the malicious PE file that is executed by the electronic device 20 and disclosed in any one of the above embodiments, the computer program 222 may further include a computer program that can be configured to complete other specific operations.

Further, the disclosed embodiment further discloses a computer-readable storage medium. The computer-readable storage medium here includes a Random Access Memory (RAM), a memory, a Read-Only Memory (ROM), an electrically programmable ROM, an electrically erasable programmable ROM, a register, a hard disk, a magnetic disk, or an optical disk, or any other form of storage media known in the technical field. The disclosed method for detecting the malicious PE file is implemented when the computer program is executed by the processor. The specific steps of the method may refer to corresponding content disclosed in the foregoing embodiments, and are not described herein again.

Each embodiment in this specification is described in a progressive manner, and each embodiment focuses on the differences from other embodiments, and the same or similar parts of each embodiment may be referred to each other. For the apparatus disclosed in the embodiments, since the apparatus corresponds to the method disclosed in the embodiments, the description is relatively simple, and for related parts, refer to the partial descriptions of the method. The professional may further realize that the units and algorithmic steps of the various examples described in combination with the embodiments disclosed herein are capable of being implemented in electronic hardware, computer software, or a combination of electronic hardware and computer software. In order to clearly illustrate the interchangeability of hardware and software, the composition and the steps of the examples have been described in the above description in general terms according to functions. Whether these functions are executed in a hardware or software manner depends on specific applications and design constraints of the technical solutions. Professionals may realize the described functions for each specific application by use of different methods, but such implementation shall fall within the scope of this application.

The steps of the method or algorithm described in combination with the embodiments disclosed herein may be implemented directly with the hardware, a software component executed by the processor, or a combination of the hardware and the software component. The software component may be provided in the RAM, the memory, the ROM, the electrically programmable ROM, the electrically erasable programmable ROM, the register, the hard disk, a removable disk, a CD-ROM, or any other form of storage media known in the technical field.

Finally, it is also to be noted that relational terms such as first and second are used merely to distinguish one entity or operation from another entity or operation herein, and do not necessarily require or imply the existence of any such actual relationship or order between these entities or operations. Furthermore, terms “comprise”, “include” or any other variants are intended to encompass non-exclusive inclusion, such that a process, a method, an article or a device including a series of elements not only include those elements, but also includes other elements not listed explicitly or includes intrinsic elements for the process, the method, the article, or the device. Without any further limitation, an element defined by the phrase “comprising one” does not exclude existence of other same elements in the process, the method, the article, or the device that includes the elements.

The method and apparatus for detecting the malicious PE file, and the device and the storage medium provided in the disclosure are introduced in detail. Detailed examples are used in this specification to describe the principles and implementations of the disclosure. The description of the above examples is merely used to facilitate understanding of the method and the core idea of the disclosure. In addition, for those of ordinary skill in the art, according to the idea of the disclosure, there will be changes in the specific implementations and the scope of application. In summary, the content of this specification should not be construed as a limitation of the disclosure.

1. A method for detecting a malicious Portable Executable (PE) file, comprising:
disassembling a target PE file according to a preset file disassembling method, so as to acquire file header information, file optional header information, file section header information, and section information corresponding to the file section header information, wherein the file header information, file optional header information and file section header information are corresponding to the target PE file;
using a trained sparse self-encoding neural network model to respectively vectorize the file header information, the file optional header information, and the file section header information, and using a trained text classification model to vectorize the section information, so as to acquire a file header vector, a file optional header vector, a file section header vector, and a section information vector;
performing vector fusion on the file header vector, the file optional header vector, the file section header vector, and the section information vector, so as to obtain fused vectors; and
inputting the fused vectors into a neural network model, so as to acquire a file detection result that is outputted by the neural network model for the target PE file, wherein the neural network model is a model that is obtained by using a preset knowledge transfer method to perform model transfer on each trained sparse self-encoding neural network model and the trained text classification model.

2. The method for detecting the malicious PE file as claimed in claim 1, wherein before using the trained sparse self-encoding neural network model to respectively vectorize the file header information, the file optional header information, and the file section header information, and using the trained text classification model to vectorize the section information, the method further comprises:
acquiring a preset number of PE sample files, wherein the PE sample files comprise a malicious PE sample file and a non-malicious PE sample file; and
disassembling the PE sample files according to the preset file disassembling method to obtain the file header information, the file optional header information, the file section header information, and the section information corresponding to the file section header information;
successively inputting the file header information, the file optional header information, the file section header information, and the section information corresponding to the file section header information into a preset first sparse self-encoding neural network model, a preset second sparse self-encoding neural network model, a preset third sparse self-encoding neural network model, and a preset text classification model for model training, so as to acquire a trained preset first sparse self-encoding neural network model, a trained preset second sparse self-encoding neural network model and a trained preset third sparse self-encoding neural network model, and a trained text classification model.

3. The method for detecting the malicious PE file as claimed in claim 2, wherein after successively inputting the file header information, the file optional header information, the file section header information, and the section information corresponding to the file section header information into the preset first sparse self-encoding neural network model, the preset second sparse self-encoding neural network model, the preset third sparse self-encoding neural network model, and the preset text classification model for model training, the method further comprises:
generating a cross entropy loss function through a probability that detection results outputted by each trained sparse self-encoding neural network model and the trained text classification model is malicious information or non-malicious information; and
adjusting, on the basis of the cross entropy loss function, target neural network parameters in each trained sparse self-encoding neural network model and the trained text classification model during a vectorization process.

4. The method for detecting the malicious PE file as claimed in claim 3, wherein after performing vector fusion on the file header vector, the file optional header vector, the file section header vector, and the section information vector, so as to obtain the fused vectors, the method further comprises:
freezing the target neural network parameters in each trained sparse self-encoding neural network model and the trained text classification model.

5. The method for detecting the malicious PE file as claimed in claim 2, wherein using the trained sparse self-encoding neural network model to respectively vectorize the file header information, the file optional header information, and the file section header information, and using the trained text classification model to vectorize the section information, so as to acquire the file header vector, the file optional header vector, the file section header vector, and the section information vector comprises:
respectively inputting fields in the file header information, the file optional header information, and the file section header information into the trained preset first sparse self-encoding neural network model, the trained preset second sparse self-encoding neural network model and the trained preset third sparse self-encoding neural network model in a preset sorting manner, and inputting the section information into the trained text classification model; and
respectively using outputs of hidden layers of the trained preset first sparse self-encoding neural network model, preset second sparse self-encoding neural network model and preset third sparse self-encoding neural network model as the file header vector, the file optional header vector, and the file section header vector, and using an output of fully connected layer in the trained text classification model as the section information vector.

6. The method for detecting the malicious PE file as claimed in claim 2, wherein before inputting the fused vectors into the neural network model, the method further comprises:
performing model transfer on the trained preset first sparse self-encoding neural network model, the trained preset second sparse self-encoding neural network model and the trained preset third sparse self-encoding neural network model, and the trained text classification model on the basis of the preset knowledge transfer method, so as to obtain the neural network model.

7. The method for detecting the malicious PE file as claimed in claim 1, wherein acquiring the file detection result that is outputted by the neural network model for the target PE file comprises:
acquiring the file detection result that is outputted by the neural network model for the target PE file and comprises eight soft label dimensions, wherein the eight soft label dimensions comprise a malicious file header, a non-malicious file header, a malicious optional header, a non-malicious optional header, a malicious section header, a non-malicious section header, a malicious section, and a non-malicious section.

8. An electronic device, comprising a processor and a memory, wherein a computer program stored in the memory is executed by the processor to cause the processor to:
disassemble a target PE file according to a preset file disassembling method, so as to acquire file header information, file optional header information, file section header information, and section information corresponding to the file section header information, wherein the file header information, file optional header information and file section header information are corresponding to the target PE file;
use a trained sparse self-encoding neural network model to respectively vectorize the file header information, the file optional header information, and the file section header information, and use a trained text classification model to vectorize the section information, so as to acquire a file header vector, a file optional header vector, a file section header vector, and a section information vector;
perform vector fusion on the file header vector, the file optional header vector, the file section header vector, and the section information vector, so as to obtain fused vectors; and
input the fused vectors into a neural network model, so as to acquire a file detection result that is outputted by the neural network model for the target PE file, wherein the neural network model is a model that is obtained by using a preset knowledge transfer method to perform model transfer on each trained sparse self-encoding neural network model and the trained text classification model.

9. A non-transitory computer-readable storage medium, storing a computer program that is executed by a processor, and upon execution by the processor, is configured to cause the processor to:
disassemble a target PE file according to a preset file disassembling method, so as to acquire file header information, file optional header information, file section header information, and section information corresponding to the file section header information, wherein the file header information, file optional header information and file section header information are corresponding to the target PE file;
use a trained sparse self-encoding neural network model to respectively vectorize the file header information, the file optional header information, and the file section header information, and use a trained text classification model to vectorize the section information, so as to acquire a file header vector, a file optional header vector, a file section header vector, and a section information vector;
perform vector fusion on the file header vector, the file optional header vector, the file section header vector, and the section information vector, so as to obtain fused vectors; and
input the fused vectors into a neural network model, so as to acquire a file detection result that is outputted by the neural network model for the target PE file, wherein the neural network model is a model that is obtained by using a preset knowledge transfer method to perform model transfer on each trained sparse self-encoding neural network model and the trained text classification model.

10. The electronic device as claimed in claim 8, the processor is further configured to:
acquire a preset number of PE sample files, wherein the PE sample files comprise a malicious PE sample file and a non-malicious PE sample file; and
disassemble the PE sample files according to the preset file disassembling method to obtain the file header information, the file optional header information, the file section header information, and the section information corresponding to the file section header information;
successively input the file header information, the file optional header information, the file section header information, and the section information corresponding to the file section header information into a preset first sparse self-encoding neural network model, a preset second sparse self-encoding neural network model, a preset third sparse self-encoding neural network model, and a preset text classification model for model training, so as to acquire a trained preset first sparse self-encoding neural network model, a trained preset second sparse self-encoding neural network model and a trained preset third sparse self-encoding neural network model, and a trained text classification model.

11. The electronic device as claimed in claim 10, the processor is further configured to:
generate a cross entropy loss function through a probability that detection results outputted by each trained sparse self-encoding neural network model and the trained text classification model is malicious information or non-malicious information; and
adjust, on the basis of the cross entropy loss function, target neural network parameters in each trained sparse self-encoding neural network model and the trained text classification model during a vectorization process.

12. The electronic device as claimed in claim 11, the processor is further configured to:
freeze the target neural network parameters in each trained sparse self-encoding neural network model and the trained text classification model.

13. The electronic device as claimed in claim 10, the processor is further configured to:
respectively input fields in the file header information, the file optional header information, and the file section header information into the trained preset first sparse self-encoding neural network model, the trained preset second sparse self-encoding neural network model and the trained preset third sparse self-encoding neural network model in a preset sorting manner, and input the section information into the trained text classification model; and
respectively use hidden layers of the trained preset first sparse self-encoding neural network model, preset second sparse self-encoding neural network model and preset third sparse self-encoding neural network model as the file header vector, the file optional header vector, and the file section header vector, and use a fully connected layer in the trained text classification model as the section information vector.

14. The electronic device as claimed in claim 10, the processor is further configured to:
perform model transfer on the trained preset first sparse self-encoding neural network model, the trained preset second sparse self-encoding neural network model and the trained preset third sparse self-encoding neural network model, and the trained text classification model on the basis of the preset knowledge transfer method, so as to obtain the neural network model.

15. The electronic device as claimed in claim 8, the processor is further configured to:
acquire the file detection result that is outputted by the neural network model for the target PE file and comprises eight soft label dimensions, wherein the eight soft label dimensions comprise a malicious file header, a non-malicious file header, a malicious optional header, a non-malicious optional header, a malicious section header, a non-malicious section header, a malicious section, and a non-malicious section.

16. The non-transitory computer-readable storage medium as claimed in claim 9, the processor is further configured to:
acquire a preset number of PE sample files, wherein the PE sample files comprise a malicious PE sample file and a non-malicious PE sample file; and
disassemble the PE sample files according to the preset file disassembling method to obtain the file header information, the file optional header information, the file section header information, and the section information corresponding to the file section header information;
successively input the file header information, the file optional header information, the file section header information, and the section information corresponding to the file section header information into a preset first sparse self-encoding neural network model, a preset second sparse self-encoding neural network model, a preset third sparse self-encoding neural network model, and a preset text classification model for model training, so as to acquire a trained preset first sparse self-encoding neural network model, a trained preset second sparse self-encoding neural network model and a trained preset third sparse self-encoding neural network model, and a trained text classification model.

17. The electronic device as claimed in claim 16, the processor is further configured to:
generate a cross entropy loss function through a probability that detection results outputted by each trained sparse self-encoding neural network model and the trained text classification model is malicious information or non-malicious information; and
adjust, on the basis of the cross entropy loss function, target neural network parameters in each trained sparse self-encoding neural network model and the trained text classification model during a vectorization process.

18. The electronic device as claimed in claim 17, the processor is further configured to:
freeze the target neural network parameters in each trained sparse self-encoding neural network model and the trained text classification model.

19. The electronic device as claimed in claim 16, the processor is further configured to:
respectively input fields in the file header information, the file optional header information, and the file section header information into the trained preset first sparse self-encoding neural network model, the trained preset second sparse self-encoding neural network model and the trained preset third sparse self-encoding neural network model in a preset sorting manner, and input the section information into the trained text classification model; and
respectively use hidden layers of the trained preset first sparse self-encoding neural network model, preset second sparse self-encoding neural network model and preset third sparse self-encoding neural network model as the file header vector, the file optional header vector, and the file section header vector, and use a fully connected layer in the trained text classification model as the section information vector.

20. The electronic device as claimed in claim 16, the processor is further configured to:
perform model transfer on the trained preset first sparse self-encoding neural network model, the trained preset second sparse self-encoding neural network model and the trained preset third sparse self-encoding neural network model, and the trained text classification model on the basis of the preset knowledge transfer method, so as to obtain the neural network model.
